(19) United States
(12) Patent Application Publication
(10) Pub. No.: US 2015/0175140 A1
(43) Pub. Date: Jun. 25, 2015

(54) BRAKING/DRIVING FORCE CONTROL DEVICE

(71) Applicant: Satoshi Shimizu, Susono-shi (JP)

(72) Inventor: Satoshi Shimizu, Susono-shi (JP)

(73) Assignee: TOYOTA JIDOSHA KABUSHIKI KAISHA, Toyota-shi, Aichi (JP)

(21) Appl. No.: 14/416,085

(22) PCT Filed: Jul. 26, 2012
(86) PCT No.: PCT/JP2012/069024

§ 371 Date: Jan. 21, 2015

(51) Int. Cl. B60T 8/76; B60T 8/172; B60W 40/076; B60W 10/04; B60W 40/105; B60T 8/171; B60W 10/188

(52) U.S. Cl. CPC B60T 8/76; B60T 8/171; B60T 8/172; B60W 10/188; B60W 10/04; B60W 40/105; B60W 40/076; B60W 2520/28; B60W 2550/142

(57) ABSTRACT

An electronic control unit includes a braking/driving force control unit configured to control a braking/driving force of a vehicle based on a detected wheel speed, a wheel speed correcting unit configured to correct a detected wheel speed of a certain wheel based on the wheel speed and a wheel speed of another wheel, and a correction prohibiting unit configured to prohibit execution of a correction control of a wheel speed by the wheel speed correcting unit while travelling on a slope road. Whether or not a travelling path of an own vehicle is a slope road is desirably determined based on a difference between an estimated vehicle body acceleration/deceleration estimated from vehicle body speed information and a detected vehicle body acceleration/deceleration detected with a vehicle body front-back acceleration sensor, or based on an output value of a power source.

### FIELD

The present invention relates to a braking/driving force control device that controls a braking/driving force of a vehicle.

### BACKGROUND

Conventionally, for this type of braking/driving force control device, a braking/driving force control device that controls a braking/driving force of a control target wheel according to the state of a vehicle such as a vehicle behavior, and the like is known. For example, when carrying out a vehicle control such as an EBD control, an ABS control, a TRC control, and the like, the braking/driving force control device adjusts the braking force and the driving force of the control target wheel while monitoring a wheel speed detected by a wheel speed sensor, a vehicle body speed estimated based on the wheel speed, a slip ratio of a wheel, and the like. All of the wheels of the vehicle may not necessarily hold a difference of an even wheel diameter (wheel radius or wheel diameter) at the time of factory shipment due to wear, and the like. At the wheel where the wheel diameter fluctuates due to wear, and the like, the detected wheel speed may possibly shift with respect to the actual wheel speed (hereinafter referred to as “actual wheel speed”). Furthermore, if the wheel diameter of each wheel differs due to fluctuation in the wheel diameter, and the like, the detection error of the wheel speed may lead to error in the computation value of the vehicle speed and the slip ratio, and hence a highly accurate braking/driving force control may not be carried out.

A technique of correcting the wheel speed has been proposed in the conventional art. As a technique of correcting the wheel speed, a technique of computing a predetermined correction value for every wheel while the vehicle is carrying out a steady travelling (travelling straight at constant speed), and factoring in the correction value for the wheel to the detected wheel speed through multiplication, addition, and the like to correct the wheel speed of each wheel is known. For example, a wheel speed correction device of Patent Literature 1 corrects a coefficient including the wheel radius for every wheel, and uses the corrected coefficient to correct to the wheel speed that takes into consideration the fluctuation in the wheel diameter involved in wear and turning operation. A method and device for correcting a wheel speed of Patent Literature 2 computes a ratio of a value corresponding to a moving distance of each wheel and a value corresponding to a moving distance of at least one other wheel as a correction coefficient, and corrects the wheel speed of each wheel with the correction coefficient while the vehicle is in a straight state.

### CITATION LIST

### Patent Literature

Patent Literature 1: Japanese Patent Application Laid-open No. 4-283665

Patent Literature 2: Japanese Patent Application Laid-open No. 10-67313

### SUMMARY

### Technical Problem

A ground load of each wheel changes with increase/reduction of a carrying capacity of a baggage. When the ground load of the drive wheel is small, a slip ratio of a drive wheel may possibly become higher than a slip ratio of a driven wheel, and the drive wheel may also show a lock tendency with respect to the driven wheel depending on a travelling situation. Under such travelling situation, even if the correction of the wheel speed such as the computation of the correction value, and the like is executed, the accuracy of the correction is low and the braking/driving force may not be performed with high accuracy.

It is an object of the present invention to overcome the drawbacks of the conventional art example, and provide a braking/driving force control device capable of carrying out the braking/driving force control with high accuracy.

### Solution to Problem

In order to achieve the above mentioned object, a braking/driving force control device according to the present invention includes a braking/driving force control unit configured to control a braking/driving force of a vehicle based on a detected wheel speed; a wheel speed correcting unit configured to correct a detected wheel speed of a certain wheel based on the wheel speed and a wheel speed of another wheel; and a correction prohibiting unit configured to prohibit execution of a correction control of the wheel speed by the wheel speed correcting unit while travelling on a slope road.

Here, it is desirable that the correction prohibiting unit prohibits the execution of the correction control of the wheel speed by the wheel speed correcting unit while steady travelling on the slope road.

Further, it is desirable that the correction prohibiting unit prohibits the execution of the correction control of the wheel speed by the wheel speed correcting unit at the time a slip ratio of either one of a drive wheel or a driven wheel becomes higher than a slip ratio of the other wheel while travelling on the slope road or at the time only one of either the drive wheel or the driven wheel shows a lock tendency while travelling on the slope road.

Further, it is desirable that whether or not a travelling path of an own vehicle is a slope road is determined based on a difference between an estimated vehicle body acceleration/deceleration estimated from vehicle body speed information and a detected vehicle body acceleration/deceleration detected by a vehicle body front-back acceleration sensor, or based on an output value of a power source.

Further, it is desirable that the braking/driving force control unit carries out a control of the braking/driving force at the time of the execution of a vehicle control.

### Advantageous Effects of Invention

In the braking/driving force control device according to the present invention, the execution of the correction control of the wheel speed is prohibited when travelling on a slope road in which a slip ratio of either one of the drive wheel or the driven wheel may become higher than the slip ratio of the other wheel or only one of either the drive wheel or the driven wheel may show the lock tendency. Thus, such braking/driving force control device avoids the braking/driving force control to a request braking force or a request driving force based on the erroneous wheel speed. Therefore, the braking/driving force control device can execute a highly accurate braking/driving force control.

### BRIEF DESCRIPTION OF DRAWINGS

FIG. 1 is a block diagram illustrating a configuration of a braking/driving force control device according to the present invention.

FIG. 2 is a view describing a ratio of a vehicle weight and a ground load of a drive wheel.

FIG. 3 is a view describing a relationship of a slip ratio corresponding to the ground load of the drive wheel and a driving force.

FIG. 4 is a view describing force acting on a vehicle travelling on an up slope road.

FIG. 5 is a flowchart describing one embodiment of an operation of the braking/driving force control device according to the present invention.

FIG. 6 is a flowchart describing another embodiment of the operation of the braking/driving force control device according to the present invention.

### DESCRIPTION OF EMBODIMENTS

An embodiment of a braking/driving force control device according to the present invention will be hereinafter described in detail based on the drawings. The present invention is not limited by such embodiment.

### Embodiment

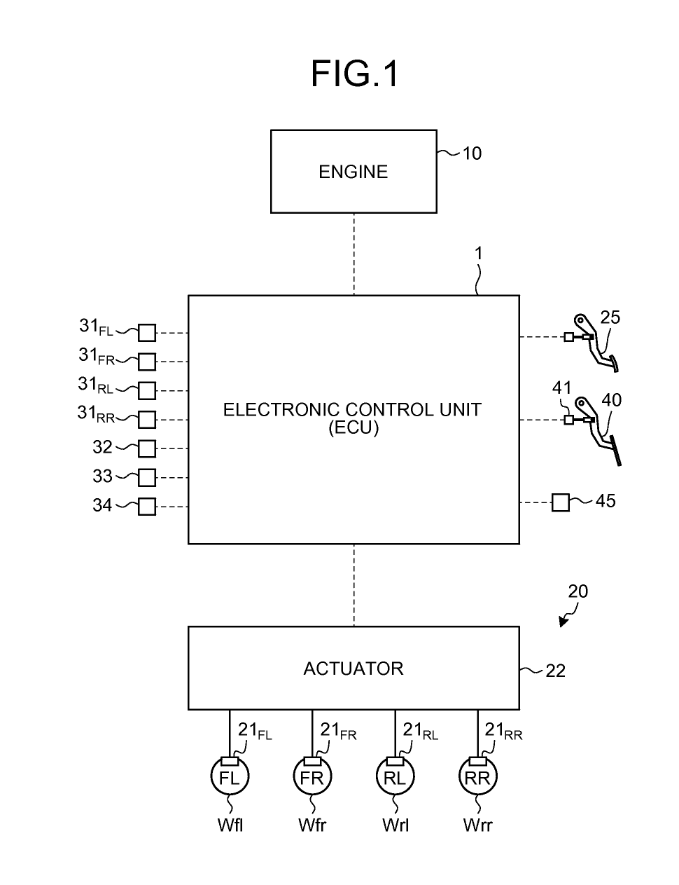

An embodiment of the braking/driving force control device according to the present invention will be described based on FIGS. 1 to 6.

The braking/driving force control device of the present embodiment controls a driving force output by a power source 10 and a braking force output by a braking device 20, where a computation processing function thereof is prepared as one function of an electronic control unit (ECU) 1.

The power source 10 is an engine, a rotating electrical machine, or the like, and generates a driving force in vehicle travelling. The driving force is controlled by a braking/driving force control unit of the electronic control unit 1, and is transmitted to a drive wheel through a power transmitting device (not illustrated) such as a transmission, and the like. The engine is a so-called engine such as an internal combustion engine, an external combustion engine, and the like, for example. The rotating electrical machine is an electrical motor, an electrical power generator, and the like. The vehicle is mounted with at least one of the engine and the rotating electrical machine for the power source 10.

The braking device 20 supplies a brake fluid pressure to a braking force generating unit (caliper etc.) 21_{FL}, 21_{FR}, 21_{RL}, 21_{RR} for each wheel Wfl, Wfr, Wrl, Wrr, and causes each wheel Wfl, Wfr, Wrl, Wrr to generate the braking force corresponding to the brake fluid pressure. The braking device 20 includes an actuator 22 serving as a brake fluid pressure adjustment unit for controlling the braking force for each wheel Wfl, Wfr, Wrl, Wrr. The actuator 22 is controlled by the braking/driving force control unit of the electronic control unit 1, and is able to supply the brake fluid pressure corresponding to an operation amount (pedal stroke, pedal depression force, etc.) of a brake pedal 25 by a driver as is or after adjustment to the braking force generating units 21_{FL}, 21_{FR}, 21_{RL}, 21_{RR}. The actuator 22 can also apply the braking force only to a specific wheel (control target wheel) among the wheels Wfl, Wfr, Wrl, Wrr.

The braking/driving force control device controls the braking/driving force of the control target wheel when carrying out the vehicle control such as the EBD control, the ABS control, the TRC control, the VSC control, and the like.

The EBD (Electronic Brake force Distribution) control is a control that monitors the wheel speed of each wheel Wfl, Wfr, Wrl, Wrr and causes each wheel Wfl, Wfr, Wrl, Wrr to generate a braking force at an appropriate target braking force distribution of each wheel Wfl, Wfr, Wrl, Wrr corresponding to the travelling situation. For example, in the brake operation on a flat road or a down slope road, the braking force is controlled at the target braking force distribution at which all the wheels Wfl, Wfr, Wrl, Wrr have an equal slip ratio so that the slip ratio of the rear wheels Wrl, Wrr does not become higher than that of the front wheels Wfl, Wfr.

The respective wheel speed is detected with a wheel rotation angle sensor 31_{FL}, 31_{FR}, 31_{RL}, 31_{RR} serving as a wheel speed detecting device arranged for every wheel Wfl, Wfr, Wrl, Wrr. The wheel rotation angle sensor 31_{FL}, 31_{FR}, 31_{RL}, 31_{RR}, for example, detects the rotation angle of the respective axle of each wheel Wfl, Wfr, Wrl, Wrr. The electronic control unit 1 receives the detection signals of the wheel rotation angle sensors 31_{FL}, 31_{FR}, 31_{RL}, 31_{RR}, and computes the wheel speed based on the detection signals. For example, the electronic control unit 1 obtains the rotation angle speed of the axle from the detection signal, and converts the rotation angle speed by a conversion value corresponding to the wheel radius, as described above, to compute the wheel speed for every wheel Wfl, Wfr, Wrl, Wrr. The electronic control unit 1 can also compute the wheel acceleration/deceleration (differential value of the wheel speed), the vehicle body speed (vehicle speed), and the travelling distance based on the detection signal.

The ABS (Anti-lock Brake System) control is a control that prevents the lock of the control target wheel by increasing/reducing the braking force of the control target wheel during braking of vehicle by the brake operation of the driver, and monitors the wheel speed of each wheel Wfl, Wfr, Wrl, Wrr and adjusts the braking force of the control target wheel that shows the lock tendency.

The TRC (Traction Control) control is a control that prevents idle running of the drive wheel by reducing the driving force of the power source 10 at the start of the vehicle and at the acceleration of the vehicle, and adjusts the driving force based on the wheel speed of the control target wheel, the vehicle body speed (vehicle speed), and the like.

The vehicle body speed is detected by a vehicle speed detecting device 32. For the vehicle speed detecting device 32, a rotation angle sensor that detects the rotation angle of the output shaft of the power transmitting device (e.g., transmission), a GPS (Global Positioning System) that can grasp the moving distance of the own vehicle position, and the like can be used. In the illustration, the wheel rotation angle sensors 31_{FL}, 31_{FR}, 31_{RL}, 31_{RR} are also used as the vehicle speed detecting device 32. The electronic control unit 1, for example, obtains an average value of the wheel speeds of each wheel Wfl, Wfr, Wrl, Wrr obtained based on the detection signals of the wheel rotation angle sensors 31_{FL}, 31_{FR}, 31_{RL}, 31_{RR}, and computes the vehicle body speed based on the average value of the wheel speeds. The electronic control unit 1 can also compute the vehicle body acceleration/deceleration (differential value of the vehicle body speed) and the travelling distance (integrated value of the vehicle body speed) based on the detection signal of the vehicle speed detecting device 32.

The VSC (Vehicle Stability Control) control is a vehicle stabilizing control that controls the braking force and the driving force of the control target wheel to generate a yaw moment in an under steer direction or an over steer direction in the vehicle body thus preventing the side skid of the vehicle body. In the VSC control, the wheel speed of each wheel Wfl, Wfr, Wrl, Wrr, the vehicle body lateral acceleration, and the like are monitored to determine the control target wheel, which becomes the control target of the braking/driving force.

The vehicle body lateral acceleration is detected by a vehicle body lateral acceleration sensor 33. The detection signal of the vehicle body lateral acceleration sensor 33 is input to the electronic control unit 1.

Thus, in the vehicle control, the information on the wheel speed is required. However, each wheel Wfl, Wfr, Wrl, Wrr may not necessarily wear evenly, and the wheel diameter (wheel radius or wheel diameter) and the grip may differ between the front wheels Wfl, Wfr and the rear wheels Wrl, Wrr, for example. The owner of the vehicle may make the wheel diameters differ between the front wheels Wfl, Wfr and the rear wheels Wrl, Wrr.

If the wheel diameter fluctuates, the detected wheel speed may possibly shift with respect to the actual wheel speed. In this case, the computation value of the slip ratio may also shift due to the detection error of the wheel speed. As described above, the vehicle body speed is obtained based on the average value of the wheel speed of each of the wheels Wfl, Wfr, Wrl, Wrr, and hence may possibly shift with respect to the actual vehicle body speed due to the fluctuation in the wheel diameter of each wheel Wfl, Wfr, Wrl, Wrr and the difference in the respective wheel diameter. Therefore, if the detection error occurs in the wheel speed, the request braking force and the request driving force are computed based on the wheel speed, the slip ratio, the vehicle body speed, and the like that are shifted with respect to the actual speed, whereby the braking force and the driving force may become excessively larger or excessively smaller than actually required force, thus lowering the accuracy of the braking/driving force control. In this case, even if the vehicle speed is detected with high accuracy without depending on the wheel speed, the accuracy of the braking/driving force control may possibly lower by the error in the wheel speed and the slip ratio. That is, if the detected wheel speed is shifted, the vehicle control of satisfactory accuracy may not be executed as the accuracy of the braking/driving force is lowered.

The electronic control unit 1 is provided with a computation processing function for correcting the wheel speeds detected by the wheel rotation angle sensors 31_{FL}, 31_{FR}, 31_{RL}, 31_{RR}. In the illustration, the correction control of the wheel speed is executed by the braking/driving force control device, but a wheel speed correction device for carrying out the correction control may be arranged.

The correction control of the wheel speed is executed by a method well known in the technical field. For example, the wheel speed correcting unit of the electronic control unit 1 computes a predetermined correction value of each wheel Wfl, Wfr, Wrl, Wrr while the vehicle is carrying out steady travelling, and factors in the correction value for the wheel Wfl, Wfr, Wrl, Wrr to the detected wheel speed through multiplication, addition, and the like to correct the wheel speed of each wheel Wfl, Wfr, Wrl, Wrr. The correction value is provided to match the detected wheel speeds of all the wheels Wfl, Wfr, Wrl, Wrr to a predetermined value. The predetermined value is, for example, an average value, and the like of the wheel speeds of each of the wheels Wfl, Wfr, Wrl, Wrr. That is, the electronic control unit 1 corrects the detected wheel speed of a certain wheel based on the wheel speed and the wheel speed of other wheels. In this case, for example, the correction value for the wheel is factored in by multiplication, and the like when computing the wheel speed of a certain wheel in which the rotation angle of the axle is detected to correct the wheel speed of the wheel so as to approach the actual wheel speed.

The electronic control unit 1 may compute a predetermined correction value for every wheel Wfl, Wfr, Wrl, Wr while the vehicle is carrying out the steady travelling, and factor in the correction values for the wheels Wfl, Wfr, Wrl, Wrr to the computation parameter of the wheel speed by multiplication, addition, and the like to correct the wheel speed of each wheel Wfl, Wfr, Wrl, Wrr. The computation parameter of the wheel speed is the parameter for every wheel Wfl, Wfr, Wrl, Wrr used when computing the wheel speed based on the detected rotation angle of the axle, and includes information on the wheel diameter. For example, in the illustration, the conversion value, and the like correspond to the computation parameter of the wheel speed. The correction value in this case is provided to correct the computation parameter of the wheel speed so as to match the detected wheels speeds of all the wheels Wfl, Wfr, Wrl, Wrr to the predetermined value. In this case, for example, the computation parameter of the wheel speed is corrected in advance with the correction value to correct the wheel speed of the wheel so as to approach the actual wheel speed using the computation parameter of after the correction for the wheel when computing the wheel speed of a certain wheel in which the rotation angle of the axle is detected. In other words, the correction of the computation parameter of the wheel speed by the correction value can be said as the correction of the wheel diameter by the correction value. That is, the wheel diameter is corrected with the correction value and the wheel speed is obtained with the computation parameter including the information on the wheel diameter of after the correction to correct the wheel speed so as to approach the actual wheel speed.

In the vehicle, the baggage compartment is generally arranged on either the front or the back of the vehicle, and thus the ground load of the wheels Wfl, Wfr, Wrl, Wrr changes depending on whether the carrying capacity of the baggage is large or small. For example, in a vehicle of a rear wheel drive having the baggage compartment on the back part side of the vehicle, the ground load becomes smaller at the drive wheels Wrl, Wrr than at the driven wheels Wfl, Wfr as the carrying capacity of the baggage becomes smaller. That is, in such a vehicle, the reduction degree of the ground load of the drive wheels Wrl, Wrr becomes large compared to the reduction degree of the ground load of the driven wheels Wfl, Wfr when the carrying capacity of the baggage becomes small. This is significant in a transport vehicle in which the increasing/reducing width of the carrying capacity of the baggage is large as represented by trucks, and the like.

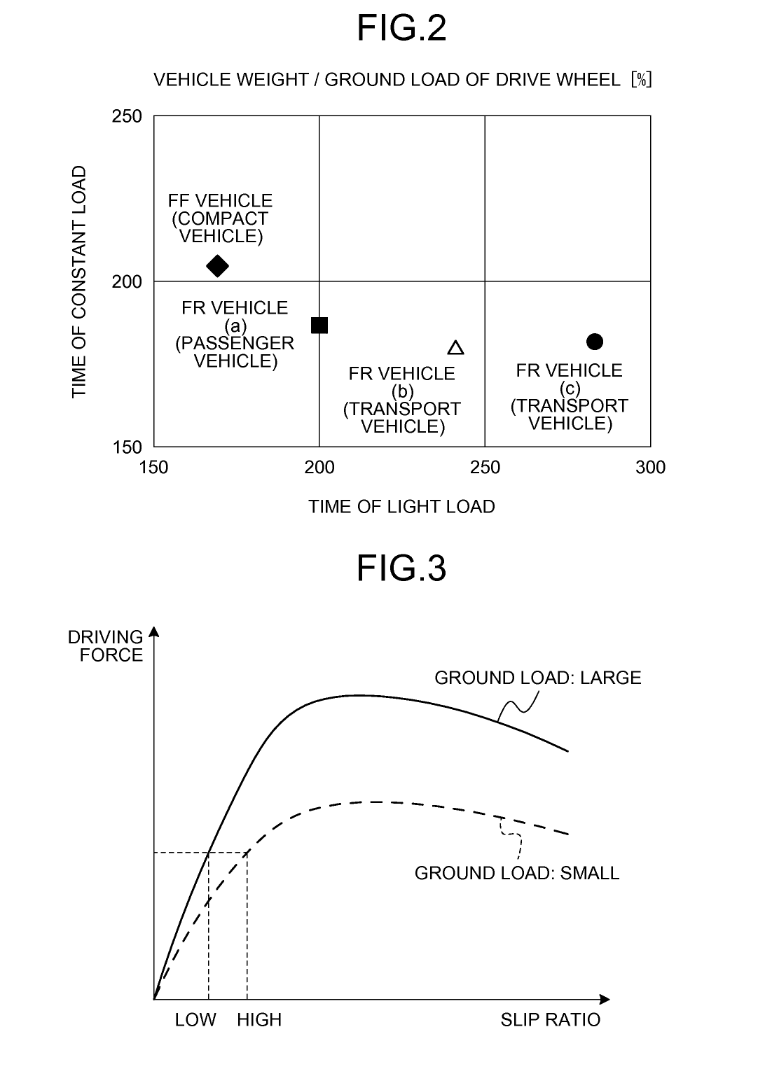

In such a vehicle, the value (hereinafter referred to as “weight ratio”) obtained by dividing the vehicle weight by the ground load of the drive wheels Wrl, Wrr becomes large. In FIG. 2, such weight ratio is indicated in percentage. The time of light load illustrated in FIG. 2 is when the carrying capacity of the baggage is small. The time of constant load is when the baggage of a defined carrying capacity (maximum carrying capacity) is loaded. In the rear wheel drive vehicle (FR vehicle herein), the weight ratio at the time of light load tends to become larger than the weight ratio at the time of constant load. In such a vehicle, the weight ratio at the time of light load becomes larger than the weight ratio at the time of constant load as the carrying capacity of the baggage becomes smaller the larger the increasing/reducing width of the carrying capacity of the baggage. The FR vehicle (a) of FIG. 2 is a typical passenger vehicle and a trunk is prepared as a baggage compartment. The FR vehicle (b) is a transport vehicle in which a loading platform or a baggage compartment is arranged on the back side of the cabin. The FR vehicle (c) is a transport vehicle in which the increasing/reducing width of the carrying capacity of the baggage is larger than the FR vehicle (b).

In this type of vehicle, when the ground load of the drive wheels Wrl, Wrr is small on a flat road and the weight ratio at the time of light load is large, the slip ratio of the drive wheels Wrl, Wrr for generating the driving force that counteracts the forces by the road surface resistance (=coefficient of friction×ground load) and the air resistance becomes high. Furthermore, on the slope road, the slip ratio of the drive wheels Wrl, Wrr for generating the driving force that counteracts the forces by the road surface resistance, the air resistance, and the gravity becomes high. The load in the perpendicular direction with respect to the road surface is assumed as the ground load regardless of the presence or absence of gradient of the travelling path.

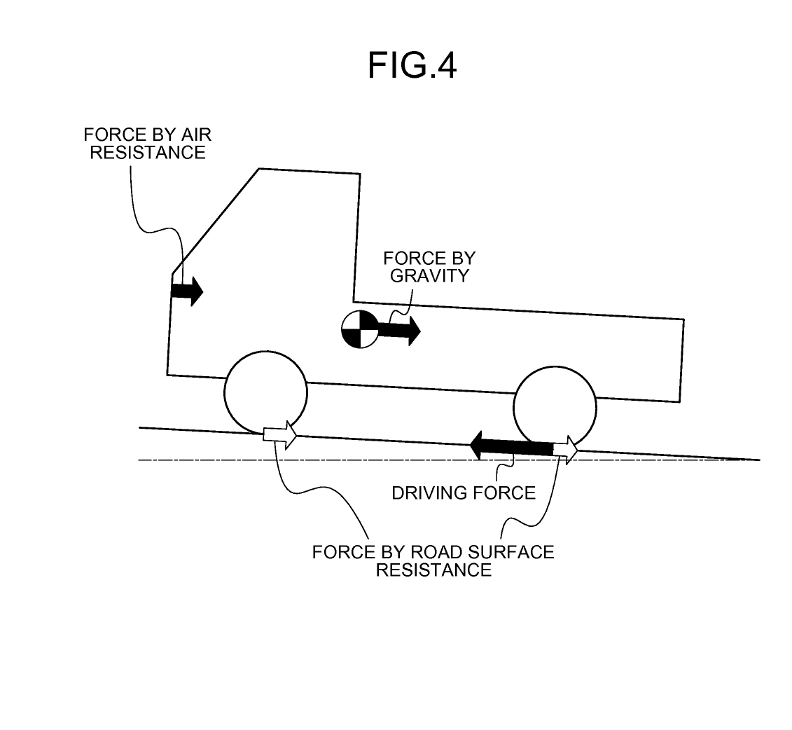

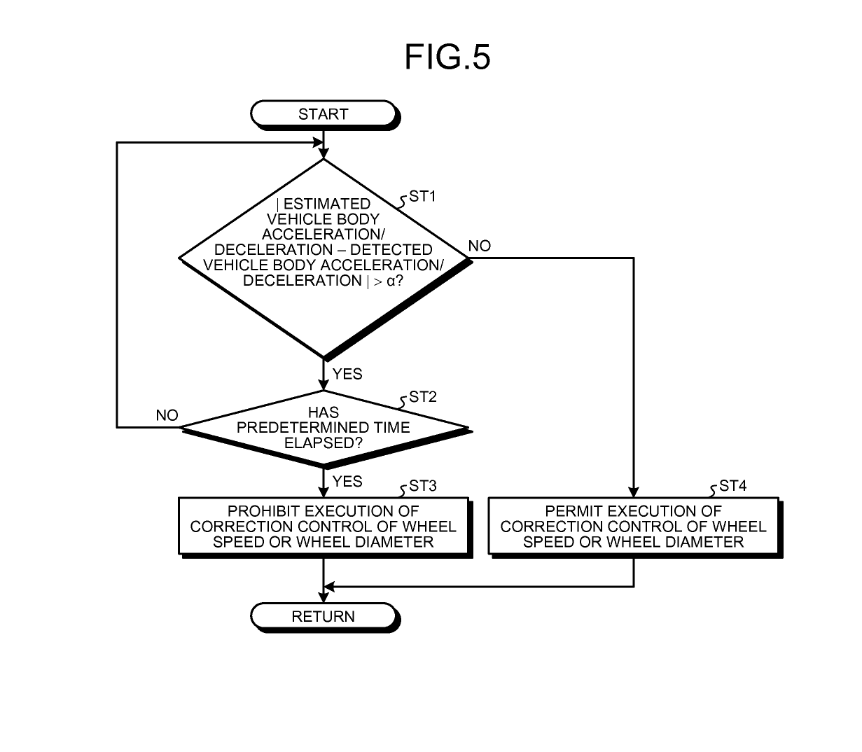

The slip ratio of the drive wheels Wrl, Wrr becomes higher the smaller the ground load of the drive wheels Wrl, Wrr when generating the driving force of the same magnitude (FIG. 3). The slip ratio becomes high when travelling on the up slope road than on the flat road. Thus, in the rear wheel drive vehicle travelling on the up slope road illustrated in FIG. 4, the slip ratio of the drive wheels Wrl, Wrr becomes higher than the slip ratio of the driven wheels Wfl, Wfr and the difference in the slip ratio becomes large between the drive wheels Wrl, Wrr and the driven wheels Wfl, Wfr the larger the reduction degree of the ground load of the drive wheels Wrl, Wrr than the reduction degree of the ground load of the driven wheels Wfl, Wfr. The vehicle sometimes climbs up the up slope road in steady travelling, in which case, the vehicle is put under the travelling situation where the slip ratio of the drive wheels Wrl, Wrr is higher than the slip ratio of the driven wheels Wfl, Wfr. In this vehicle, even if the correction control of the wheel speed described above is executed in such travelling situation and the correction value is computed, the accuracy of the correction value may be low. Therefore, the wheel speed may not be corrected with satisfactory accuracy with the correction value computed under such travelling situation. Thus, when the correction control of the wheel speed is carried out under such travelling situation, the braking/driving force control cannot be executed at high accuracy and the accuracy of the vehicle control may lower.

In the vehicle in which the slip ratio of the drive wheels Wrl, Wrr is higher than the slip ratio of the driven wheels Wfl, Wfr, the drive wheel Wrl, Wrr may possibly show the lock tendency compared to the driven wheel Wfl, Wfr when generating the braking force at each wheel Wfl, Wfr, Wrl, Wrr and travelling the down slope road. The cause of generation of the braking force is at least one of the braking device 20 or the engine brake. The lock tendency of the drive wheels Wrl, Wrr becomes stronger when the braking force of both the braking device 20 and the engine brake is applied. Such a vehicle may travel down the down slope road in steady travelling, where if the drive wheel Wrl, Wrr is locked in this case, the accuracy of the computed correction value has a possibility of being low even if the correction control of the wheel speed described above is executed in such travelling situation. Therefore, in this case as well, the wheel speed has a possibility of not being corrected with satisfactory accuracy in such a vehicle, and thus the braking/driving force control cannot be executed at high accuracy, and the accuracy of the vehicle control may lower.

FIG. 2 also illustrates a vehicle (FF vehicle herein) that is a front wheel drive having a baggage compartment on the back part side of the vehicle. The FF vehicle is a compact vehicle referred to as a so-called 2 BOX vehicle and has the baggage compartment on the back side of the back seat. In such a vehicle, the ground load of the drive wheels Wfl, Wfr becomes smaller with reduction in the carrying capacity of the baggage, but the weight ratio at the time of light load is smaller than the weight ratio at the time of constant load since the power source 10 is arranged on the drive wheel Wfl, Wfr. In such a vehicle, even if the carrying capacity of the baggage is reduced, the reduction degree of the ground load of the drive wheel Wfl, Wfr is smaller than the reduction degree of the ground load of the driven wheel Wrl, Wrr. Thus, in such a vehicle, the possibility that the slip ratio of the drive wheels Wfl, Wfr becomes high is low when the carrying capacity of the baggage is reduced. Therefore, the possibility that the slip ratio of the drive wheels Wfl, Wfr becomes higher than the slip ratio of the driven wheels Wrl, Wrr while travelling on the up slope road is low in such a vehicle compared to the back wheel drive vehicle. Even in such a vehicle, when travelling on the down slope road with the engine brake, the drive wheels Wfl, Wfr have a possibility of showing the lock tendency compared to the driven wheels Wrl, Wrr. The vehicle has a possibility in which the lock tendency of the drive wheels Wfl, Wfr becomes stronger when the braking force of the braking device 20 is further generated to each wheel Wfl, Wfr, Wrl, Wrr in this case. Thus, when travelling down the down slope road with steady travelling with at least the engine brake, even such a vehicle may lack in the accuracy of the computed correction value and the wheel speed may not be corrected with satisfactory accuracy, and hence the braking/driving force control cannot be executed at high accuracy and the accuracy of the vehicle control may lower.

The braking/driving force control device of the present embodiment prohibits the execution of the correction control of the wheel speed or the correction control of the wheel diameter under the travelling situation where the accuracy of the correction of the wheel speed lowers even during the steady travelling. The electronic control unit 1 includes a correction prohibiting unit that prohibits the execution of the correction control of the wheel speed or the correction control of the wheel diameter under a predetermined condition. Specifically, while travelling on the slope road, the execution of the correction control of the wheel speed or the correction control of the wheel diameter is prohibited even if the steady travelling is being carried out. When travelling on the flat road, on the other hand, the execution of the correction control of the wheel speed or the correction control of the wheel diameter is permitted, and the correction control of the wheel speed or the wheel diameter is executed during the steady travelling.

One embodiment of the computation process will be described based on a flowchart of FIG. 5.

The electronic control unit 1 determines whether or not the own vehicle is travelling on the slope road. Whether or not the own vehicle is travelling on the slope road is determined by determining whether or not an absolute value of a difference between an estimated vehicle body acceleration/deceleration estimated from the vehicle body speed information and a detected vehicle body acceleration/deceleration detected with a vehicle body front-back acceleration sensor 34 is larger than a predetermined value α, and whether or not a state in which the absolute value is larger than the predetermined value α is continued for a predetermined time.

The electronic control unit 1 first determines whether or not the absolute value of the difference between the estimated vehicle body acceleration/deceleration and the detected vehicle body acceleration/deceleration is larger than the predetermined value α (step ST1).

In the illustrated vehicle, an average value of the wheel speeds of each of the wheels Wfl, Wfr, Wrl, Wrr obtained based on the detection signals of the wheel rotation angle sensors 31_{FL}, 31_{FR}, 31_{RL}, 31_{RR} is obtained, and the computation is carried out based on the average value of the wheel speeds to acquire the information of the vehicle body speed. Therefore, when the vehicle (in particular, back wheel drive vehicle) is travelling on the up slope road, the possibility the slip ratio of the drive wheel is higher than the slip ratio of the driven wheel is high, where if such difference is large, the detection accuracy of the wheel speed of the drive wheel becomes low. When the vehicle (back wheel drive vehicle and front wheel drive vehicle) is travelling on the down slope road with the braking force of the engine brake and the braking device 20, the possibility that the drive wheel will show the lock tendency with respect to the driven wheel is high, where if only the drive wheel is locked, the detection accuracy of the wheel speed of the drive wheel becomes low. Therefore, if the detection accuracy of the wheel speed of the drive wheel is lowered in such manner, the accuracy of the vehicle body speed also lowers if the vehicle body speed is obtained from the average value of the wheel speeds of all the wheels Wfl, Wfr, Wrl, Wrr. Thus, in step ST1, the vehicle body speed is computed based on only the wheel speeds of the driven wheels, and the estimated vehicle body acceleration/deceleration (differential value of the vehicle body speed) is obtained based on the vehicle body speed. In this case, the vehicle body speed may be computed from the wheel speed of one driven wheel, or may be computed from the average value of the wheel speeds of all the driven wheels to enhance the accuracy.

If the vehicle body speed is computed based on the rotation angle of the output shaft of the power transmitting device, the rotation of the output shaft may be subjected to the influence of slip and lock of the drive wheel, and hence in this case as well, the estimated vehicle body acceleration/deceleration is to be obtained from the vehicle body speed computed based on only the wheel speed of the driven wheel.

When computing the vehicle body speed using the GPS, the estimated vehicle body acceleration/deceleration may be computed based on the vehicle body speed, or the estimated vehicle body acceleration/deceleration may be computed based on the vehicle body speed obtained from only the wheel speeds of the driven wheels described above.

The predetermined value α of step ST1 is to be set to the absolute value of the detected vehicle body acceleration/deceleration detected by the vehicle body front-back acceleration sensor 34 while travelling on the slope road, for example. This is because when steady travelling on the slope road, the estimated vehicle body acceleration/deceleration becomes zero or substantially zero, and the vehicle body acceleration/deceleration in the front and back direction of the vehicle corresponding to the gradient of the slope road is detected by the vehicle body front-back acceleration sensor 34. Furthermore, even when acceleration travelling or deceleration travelling on the slope road is performed, the estimated vehicle body acceleration/deceleration becomes a value corresponding to the acceleration/deceleration travelling, and the sum of the vehicle body acceleration/deceleration corresponding to the acceleration/deceleration travelling and the vehicle body acceleration/deceleration corresponding to the gradient of the slope road is detected by the vehicle body front-back acceleration sensor 34.

The predetermined value α may be set to a value in which the flat road and the slope road can be distinguished. However, in the case of the slope road having a very small gradient, each of the wheels Wfl, Wfr, Wrl, Wrr is assumed to indicate a movement substantially the same as on the flat road. Therefore, the predetermined value α may be set to the absolute value of the detected vehicle body acceleration/deceleration of when travelling on the slope road having a minimum gradient so as to prohibit the execution of the correction control of the wheel speed or the wheel diameter, for example. The minimum gradient to prohibit the execution of the correction control of the wheel speed or the wheel diameter is, for example, a gradient in which the slip ratio of the drive wheel becomes higher than the slip ratio of the driven wheel so that the correction control cannot obtain the desired accuracy, a gradient in which the drive wheel tends to be locked so that the correction control cannot obtain the desired accuracy, and the like. The minimum gradient varies according to vehicle speed, road surface friction coefficient, and the like even with respect to the same vehicle. Thus, the predetermined value α may be a variable value corresponding to the vehicle speed, the road surface friction coefficient, and the like.

As described above, in the illustrated embodiment, whether or not a state for determining as the slope road (state in which the absolute value of the difference between the estimated vehicle body acceleration/deceleration and the detected vehicle body acceleration/deceleration is larger than the predetermined value α) is continued for a predetermined time is determined. Thus, if the absolute value of the difference between the estimated vehicle body acceleration/deceleration and the detected vehicle body acceleration/deceleration is larger than the predetermined value α, the electronic control unit 1 determines whether or not a predetermined time has elapsed in such state (step ST2). This determination is made to exclude errors such as noise, and the like in the wheel rotation angle sensors 31_{FL}, 31_{FR}, 31_{RL}, 31_{RR} and the vehicle body front-back acceleration sensor 34. Therefore, the predetermined time is determined based on the computation period of the electronic control unit 1, the detection periods of the wheel rotation angle sensors 31_{FL}, 31_{FR}, 31_{RL}, 31_{RR}, the vehicle body front-back acceleration sensor 34, and the like. For example, the predetermined time is to be set in accordance with a plurality of computation periods or a plurality of detection periods to exclude errors such as a temporary noise, and the like.

In the illustration, if the absolute value of the difference between the estimated vehicle body acceleration/deceleration and the detected vehicle body acceleration/deceleration is larger than the predetermined value α and such state is continued for a predetermined time through steps ST1, ST2, (Yes in ST1→Yes in ST2), positive determination of travelling on the slope road is made. In this case, if determined with the predetermined value α corresponding to the minimum gradient, positive determination of travelling on the slope road is made to prohibit the execution of the correction control of the wheel speed or the wheel diameter. In the illustration, if the absolute value of the difference between the estimated vehicle body acceleration/deceleration and the detected vehicle body acceleration/deceleration is larger than the predetermined value α but such state is not continued for a predetermined time (Yes in ST1→No in ST2→No in ST1), or if the absolute value is not larger than the predetermined value α in step ST1 (No in ST1) through steps ST1, ST2, negative determination of not travelling on the slope road is made. In this case, if determined with the predetermined value α corresponding to the minimum gradient, negative determination of not travelling on the slope road is made to prohibit the execution of the correction control of the wheel speed or the wheel diameter. Furthermore, if determined with the predetermined value α for merely distinguishing the flat road and the slope road, negative determination of travelling on the flat road (not travelling on slope road) is made. Therefore, the process proceeds to step ST3 when determined that the predetermined time has elapsed in step ST2, and returns to step ST1 when determined that the predetermined time has not elapsed.

When determining that the predetermined time has elapsed in step ST2, the electronic control unit 1 prohibits the execution of the correction control of the wheel speed or the wheel diameter since the travelling path of the own vehicle is the slope road or is the slope road where the execution of the correction control of the wheel speed or the wheel diameter needs to be prohibited (step ST3). In the illustration, the computation of the correction value described above is prohibited.

When determining that the absolute value of the difference between the estimated vehicle body acceleration/deceleration and the detected vehicle body acceleration/deceleration is not larger than the predetermined value α in step ST1, or when determining that the predetermined time has not elapsed in step ST2, and determining that the absolute value of the difference between the estimated vehicle body acceleration/deceleration and the detected vehicle body acceleration/deceleration is not larger than the predetermined value α in the returned step ST1, the electronic control unit 1 permits the execution of the correction control of the wheel speed or the wheel diameter since the travelling path of the own vehicle is not the slope road or is not the slope road where the execution of the correction control of the wheel speed or the wheel diameter needs to be prohibited (step ST4).

Thus, the braking/driving force control device prohibits the execution of the correction control of the wheel speed or the wheel diameter under the travelling situation that leads to lowering of accuracy. Therefore, the braking/driving force control device can prevent the setting of the request braking force or the request driving force based on the erroneous wheel speed, so that a highly accurate braking/driving force control can be performed. The braking/driving force control device can perform the highly accurate braking/driving force control even in the vehicle control and can avoid the intervention of the unnecessary vehicle control, the intervention of excessive vehicle control, and the like, whereby the accuracy of the vehicle control can be enhanced. Such useful effects are more significantly obtained in the transport vehicle such as the truck in which the increase/reduction of the carrying capacity of the baggage is large.

In the EBD control, for example, the shift of the target braking force distribution of each wheel Wfl, Wfr, Wrl, Wrr based on the erroneous wheel speed can be avoided, and the execution of the unbalanced braking force control is avoided at each wheel Wfl, Wfr, Wrl, Wrr involved in the shift. Thus, the braking/driving force control device can prevent the change in the vehicle behavior involved in the change in the useless yaw moment.

In the ABS control, for example, an event in which determination is made as not being in the lock tendency although the wheels Wfl, Wfr, Wrl, Wrr are actually showing the lock tendency, or an event in which determination is made as being in the lock tendency although the wheels Wfl, Wfr, Wrl, Wrr are actually not showing the lock tendency based on the erroneous wheel speed can be avoided. Thus, the braking/driving force control device can achieve stabilization of the vehicle behavior by intervening the ABS control when necessary, and can reduce the possibility of the distance to stopping to become unnecessarily long by not intervening the ABS control when unnecessary.

In the TRC control, for example, an event in which determination is made that idle running is not being carried out although the drive wheel is actually idle running or an event in which determination is made that idle running is being carried out although the drive wheel is not actually idle running based on the erroneous wheel speed can be avoided. Thus, the braking/driving force control device can achieve stabilization of the vehicle behavior by intervening the TRC control when necessary, and can avoid lack of acceleration due to the useless driving force reduction by not intervening the TRC control when unnecessary.

In the VSC control, for example, the setting of the request braking/driving force with deficiency and excess of the control target wheel based on the erroneous wheel speed can be avoided. Thus, the braking/driving control device can prevent the change in the vehicle behavior involved in the change in the useless yaw moment.

The correction control of the wheel speed or the wheel diameter is performed at the time of steady travelling. Thus, in the illustration of FIG. 5, determination may be made on whether or not the own vehicle is steady travelling before carrying out the determination of step ST1. In such determination, for example, determination is made that the own vehicle is steady travelling when travelling is carried out at a constant speed and the steering wheels Wfl, Wfr are not turned. Whether or not travelling at a constant speed may be determined based on the estimated vehicle body acceleration/deceleration of step ST1, for example, where determination is made as travelling at a constant speed when the estimated vehicle body acceleration/deceleration is zero or substantially zero. Whether or not the steering wheels Wfl, Wfr are turned may be determined based on the steering angle of the steering wheel (not illustrated), where determination is made as travelling straight when the steering angle is zero or substantially zero.

The electronic control unit 1 does not correspond to the performing conditions of the correction control of the wheel speed or the wheel diameter unless the own vehicle is steady travelling, and thus once terminates the series of computation processes of FIG. 5. If the own vehicle is steady travelling, the electronic control unit 1 proceeds to step ST1.

In the illustration described up to now, the determination on whether or not travelling on the slope road is made by using the difference between the estimated vehicle body acceleration/deceleration estimated from the vehicle body speed information and the detected vehicle body acceleration/deceleration detected by the vehicle body front-back acceleration sensor 34. Such determination may be performed as below.

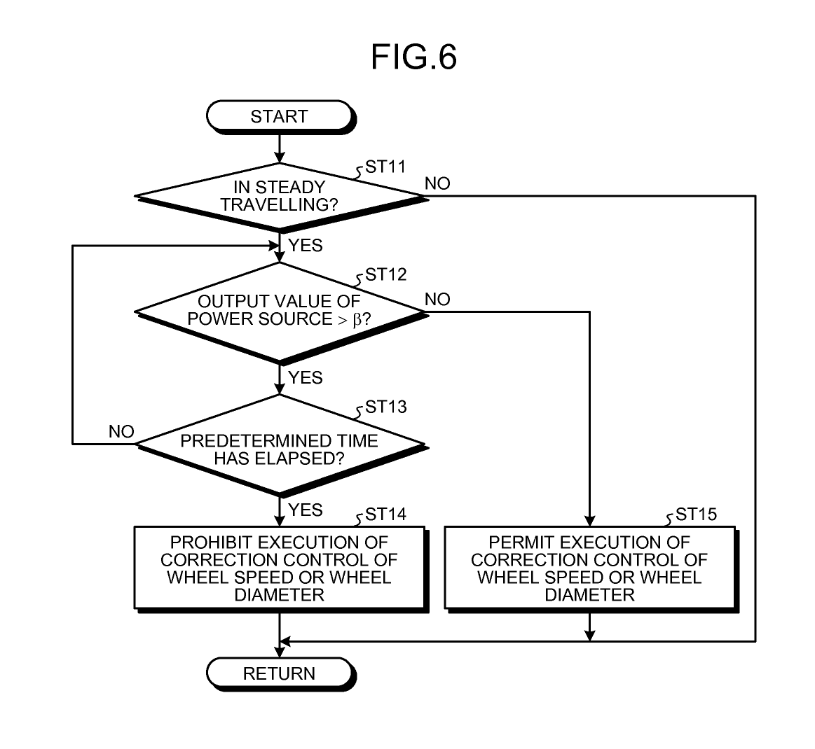

For example, as illustrated in the flowchart of FIG. 6, the electronic control unit 1 determines whether or not the own vehicle is steady travelling (step ST11). The determination may be carried out similar to the description made above.

If the own vehicle is not steady travelling, the electronic control unit 1 once terminates the computation process. If the own vehicle is steady travelling, the electronic control unit 1 determines whether or not the own vehicle is travelling the up slope road based on the output value of the power source 10.

As described above, on the flat road, the driving force that counteracts the respective forces by the road surface resistance and the air resistance needs to be output by the power source 10. In the up slope road, the driving force that counteracts the respective forces by the road surface resistance, the air resistance, and the gravity needs to be output by the power source 10. In the down slope road, the driving force that counteracts the force obtained by subtracting the force by the gravity from the respective forces by the road surface resistance and the air resistance needs to be output by the power source 10. Therefore, when travelling at a constant speed on the up slope road, the power source 10 outputs a larger driving force compared to when travelling at a constant speed on the flat road or the down slope road.

The determination on whether or not the output value of the power source 10 is larger than a predetermined value β and whether or not a state in which the output value is larger than the predetermined value β is continued for a predetermined time are carried out to determine whether or not the own vehicle is travelling on the up slope road. Therefore, the electronic control unit 1 first determines whether or not the output value of the power source 10 is larger than the predetermined value β (step ST12). The predetermined value β is determined based on an output difference of the power source 10 in the flat road and the up slope road, for example. If the minimum gradient of the up slope road described above is determined, the output difference of the power source 10 of when travelling at a constant speed on the up slope road having the minimum gradient and when travelling at a constant speed on the flat road may be defined as the predetermined value β.

The output value of the power source 10 at the time of the determination is calculated from an operation amount of an accelerator pedal 40, a throttle opening, and the like. Therefore, step ST12 may be replaced with a comparison of the operation amount of the accelerator pedal 40 and a predetermined value β1 (operation amount of the accelerator pedal 40 corresponding to the predetermined value β) or a comparison of the throttle opening and a predetermined value β2 (throttle opening corresponding to the predetermined value β). The operation amount of the accelerator pedal 40 is an accelerator opening, a stroke amount of the accelerator pedal 40, and the like, and is detected by a pedal opening sensor 41. The throttle opening is detected by a throttle opening sensor 45.

As described above, in the illustration, whether or not a state that can be determined as the slope road (state in which the output value of the power source 10 is larger than the predetermined value β, a state in which the operation amount of the accelerator pedal 40 is larger than the predetermined value β1, and a state in which the throttle opening is larger than the predetermined value β2) is continued for a predetermined time is considered. Thus, if the output value of the power source 10 is larger than the predetermined value β (the operation amount of the accelerator pedal 40 is larger than the predetermined value β1, or the throttle opening is larger than the predetermined value β2), the electronic control unit 1 determines whether a predetermined time has elapsed in such state (step ST13). This determination is carried out to exclude the temporary increase in the output of the power source 10 such as passing acceleration, and the like. Therefore, the predetermined time is set to a length longer than such temporary increasing time of the output of the power source 10, and with which determination can be made as travelling at a constant speed on the up slope road.

In the illustration, when the output value of the power source 10 is larger than the predetermined value β (the operation amount of the accelerator pedal 40 is larger than the predetermined value β1, or the throttle opening is larger than the predetermined value (2) and such state is continued for a predetermined time through steps ST12, ST13 (Yes in ST12→Yes in ST13), positive determination of travelling on the up slope road is made. In this case, if determined with the predetermined value β (β1, β2) corresponding to the minimum gradient, positive determination of travelling on the up slope road is made to prohibit the execution of the correction control of the wheel speed or the wheel diameter. In the illustration, when the output value of the power source 10 is larger than the predetermined value β (the operation amount of the accelerator pedal 40 is larger than the predetermined value β1, or the throttle opening is larger than the predetermined value β2) but such state is not continued for a predetermined time (Yes in ST12→No in ST13→No in ST12), or when the output value of the power source 10 (operation amount of the accelerator pedal 40, or the throttle opening) is not larger than the predetermined value β (β1, or β2) (No in ST12) through steps ST12, ST13, negative determination of not travelling on the up slope road is made. In this case, if determined with the predetermined value β (β1, β2) corresponding to the minimum gradient, negative determination of not travelling on the up slope road is made to prohibit the execution of the correction control of the wheel speed or the wheel diameter. If determined with the predetermined value β (β1, β2) for merely distinguishing the flat road, the down slope road, and the up slope road, negative determination of not travelling on the up slope road travelling is made. Therefore, the process proceeds to step ST14 when determined that the predetermined time has elapsed in step ST13, and returns to step ST12 when determined that the predetermined time has not elapsed.

When determining that the predetermined time has elapsed in step ST13, the electronic control unit 1 prohibits the execution of the correction control of the wheel speed or the wheel diameter since the travelling path of the own vehicle is the up slope road or is the up slope road where the execution of the correction control of the wheel speed or the wheel diameter needs to be prohibited (step ST14). In the illustration, the computation of the correction value described above is prohibited.

When determining that the output value of the power source 10 is not larger than the predetermined value β (the operation amount of the accelerator pedal 40 is not larger than the predetermined value β1 or the throttle opening is not larger than the predetermined value β2) in step ST12, or when determining that the predetermined time has not elapsed in step ST13 and determining that the output value of the power source 10 is not larger than the predetermined value β (the operation amount of the accelerator pedal 40 is not larger than the predetermined value β1 or the throttle opening is not larger than the predetermined value β2) in the returned step ST12, the electronic control unit 1 permits the execution of the correction control of the wheel speed or the wheel diameter since the travelling path of the own vehicle is not the up slope road or is not the up slope road where the execution of the correction control of the wheel speed or the wheel diameter needs to be prohibited (step ST15).

Thus, the braking/driving force control device prohibits the execution of the correction control of the wheel speed or the wheel diameter under the travelling situation that leads to lowering of the accuracy. Therefore, the braking/driving force control device can prevent the setting of the request braking force or the request driving force based on the erroneous wheel speed, so that a highly accurate braking/driving force control can be performed. Furthermore, the braking/driving force control device can perform the highly accurate braking/driving force control even in the vehicle control and can avoid the intervention of the unnecessary vehicle control, the intervention of the excessive vehicle control, and the like, whereby the accuracy of the vehicle control can be enhanced. Such useful effects are more significantly obtained in the transport vehicle such as a truck, and the like in which the increase/reduction of the carrying capacity of the baggage is large.

The braking/driving force control device may be caused to perform the determination on whether or not steady travelling the down slope road, and prohibit the execution of the correction control of the wheel speed or the wheel diameter when steady travelling on the down slope road. For example, such determination may be made based on the braking force by the engine brake of the power source 10 or the braking force of the braking device 20. The braking force by the engine brake is obtained from the rotation number of the output shaft of the power source 10, the speed change ratio of the transmission, and the like. When steady travelling on the down slope road with the engine brake, the braking force by the engine brake becomes large compared to when steady travelling on the flat road with the engine brake. Thus, when the braking force by the engine brake exceeds a predetermined value, the electronic control unit 1 can determine as travelling on the down slope road. When steady travelling on the down slope road with the braking force of the braking device 20, the braking force of the braking device 20 becomes large compared to when steady travelling on the flat road with the braking force. Thus, when the braking force of the braking device 20 exceeds a predetermined value, the electronic control unit 1 can determine as travelling on the down slope road.

Up to this point, description has been made that the execution of the correction control of the wheel speed or the wheel diameter needs to be prohibited when the slip ratio of the drive wheel becomes larger than the slip ratio of the driven wheel (in particular, when the slip ratio of the drive wheel becomes greatly larger than the slip ratio of the driven wheel) while travelling on the slope road or while steady travelling on the slope road. Furthermore, description has made up to this point that the execution of the correction control of the wheel speed or the wheel diameter needs to be prohibited when only the drive wheel shows lock tendency while travelling on the slope road or while the steady travelling on the slope road. However, such prohibition is to be carried out also when the slip ratio of the driven wheel becomes larger than the slip ratio of the drive wheel (in particular, when the slip ratio of the driven wheel becomes greatly larger than the slip ratio of the drive wheel) while travelling on the slope road or while steady travelling on the slope road, and is to also be carried out when only the driven wheel shows the lock tendency while travelling on the slope road or while the steady travelling on the slope road. That is, the braking/driving force control device desirably prohibits the execution of the correction control of the wheel speed or the wheel diameter when the slip ratio of either one of the drive wheel or the driven wheel becomes higher than the slip ratio of the other wheel while travelling on the slope road or while steady travelling on the slope road, and when only either one of the drive wheel or the driven wheel shows the lock tendency while travelling on the slope road or while steady travelling on the slope road. In the illustration described above, whether or not the execution of the correction control of the wheel speed or the wheel diameter is to be executed is determined through the determination on whether or not the own vehicle is travelling on the slope road or whether or not the own vehicle is steady travelling on the slope road regardless of whether the wheel making a large slip or having the lock tendency is the drive wheel or the driven wheel. Therefore, in the illustration made above, the execution of the correction control of the wheel speed or the wheel diameter is prohibited when the slip ratio of the driven wheel becomes larger than the slip ratio of the drive wheel while travelling on the slope road or while steady travelling on the slope road, and when only the driven wheel shows the lock tendency while travelling on the slope road or while steady travelling on the slope road.

The braking/driving force control device may carry out not only the determination on only whether or not such own vehicle is travelling on the slope road or whether or not the own vehicle is steady travelling on the slope road, but also the narrowing of the condition of prohibiting the execution of the correction control of the wheel speed or the wheel diameter under a more detailed condition. To this end, for example, the electronic control unit 1 may prohibit the execution of the correction control of the wheel speed or the wheel diameter when the slip ratio of either one of the drive wheel or the driven wheel becomes higher than the slip ratio of the other wheel while travelling on the slope road travelling or while steady travelling of the slope road. Furthermore, the electronic control unit 1 may prohibit the execution of the correction control of the wheel speed or the wheel diameter when only one of either the drive wheel or the driven wheel shows the lock tendency while travelling on the slope road or while steady travelling on the slope road.

### REFERENCE SIGNS LIST

1 ELECTRONIC CONTROL UNIT
10 POWER SOURCE
20 BRAKING DEVICE
31_{FL}, 31_{FR}, 31_{RL}, 31_{RR} WHEEL ROTATION ANGLE SENSOR
32 VEHICLE SPEED DETECTING DEVICE
33 VEHICLE BODY LATERAL ACCELERATION SENSOR
34 VEHICLE BODY FRONT-BACK ACCELERATION SENSOR
41 PEDAL OPENING SENSOR
45 THROTTLE OPENING SENSOR
Wfl, Wfr, Wrl, Wrr WHEEL

1. A braking/driving force control device comprising:
a braking/driving force control unit configured to control a braking/driving force of a vehicle based on a detected wheel speed;
a wheel speed correcting unit configured to correct a detected wheel speed of a certain wheel based on the wheel speed and a wheel speed of another wheel; and
a correction prohibiting unit configured to prohibit execution of a correction control of the wheel speed by the wheel speed correcting unit while travelling on a slope road.

2. The braking/driving force control device according to claim 1, wherein
the correction prohibiting unit prohibits the execution of the correction control of the wheel speed by the wheel speed correcting unit while steady travelling on the slope road.

3. The braking/driving force control device according to claim 1, wherein
the correction prohibiting unit prohibits the execution of the correction control of the wheel speed by the wheel speed correcting unit at the time a slip ratio of either one of a drive wheel or a driven wheel becomes higher than a slip ratio of the other wheel while travelling on the slope road or at the time only one of either the drive wheel or the driven wheel shows a lock tendency while travelling on the slope road.

4. The braking/driving force control device according to claim 1, wherein
whether or not a travelling path of an own vehicle is a slope road is determined based on a difference between an estimated vehicle body acceleration/deceleration estimated from vehicle body speed information and a detected vehicle body acceleration/deceleration detected by a vehicle body front-back acceleration sensor, or based on an output value of a power source.

5. The braking/driving force control device according to claim 1, wherein
the braking/driving force control unit carries out a control of the braking/driving force at the time of the execution of a vehicle control.

6. The braking/driving force control device according to claim 2, wherein
the correction prohibiting unit prohibits the execution of the correction control of the wheel speed by the wheel speed correcting unit at the time a slip ratio of either one of a drive wheel or a driven wheel becomes higher than a slip ratio of the other wheel while travelling on the slope road or at the time only one of either the drive wheel or the driven wheel shows a lock tendency while travelling on the slope road.

7. The braking/driving force control device according to claim 2, wherein
whether or not a travelling path of an own vehicle is a slope road is determined based on a difference between an estimated vehicle body acceleration/deceleration estimated from vehicle body speed information and a detected vehicle body acceleration/deceleration detected by a vehicle body front-back acceleration sensor, or based on an output value of a power source.

8. The braking/driving force control device according to claim 3, wherein
whether or not a travelling path of an own vehicle is a slope road is determined based on a difference between an estimated vehicle body acceleration/deceleration estimated from vehicle body speed information and a detected vehicle body acceleration/deceleration detected by a vehicle body front-back acceleration sensor, or based on an output value of a power source.

9. The braking/driving force control device according to claim 2, wherein
the braking/driving force control unit carries out a control of the braking/driving force at the time of the execution of a vehicle control.

10. The braking/driving force control device according to claim 3, wherein
the braking/driving force control unit carries out a control of the braking/driving force at the time of the execution of a vehicle control.
